(19) United States
(12) Patent Application Publication
(10) Pub. No.: US 2023/0364784 A1
(43) Pub. Date: Nov. 16, 2023

(54) CONTROL SYSTEM, CONTROL METHOD, AND STORAGE MEDIUM

(71) Applicant: TOYOTA JIDOSHA KABUSHIKI KAISHA, Toyota-shi (JP)

(72) Inventors: Kei Yoshikawa, Nagoya-shi Aichi-ken (JP); Shiro Oda, Anjo-shi (JP); Susumu Shimizu, Setagaya-ku (JP); Takeshi Matsui, Nissin-shi (JP)

(73) Assignee: TOYOTA JIDOSHA KABUSHIKI KAISHA, Toyota-shi (JP)

(21) Appl. No.: 18/124,892

(22) Filed: Mar. 22, 2023

(30) Foreign Application Priority Data
May 11, 2022 (JP) 2022-078009

(51) Int. Cl. B25J 9/16; B25J 11/00; B25J 19/02; G06V 40/10; G06V 10/56; G06V 10/70

(52) U.S. Cl. CPC B25J 9/161; B25J 11/008; B25J 19/023; G06V 40/10; G06V 10/56; G06V 10/87

(57) ABSTRACT

A control system according to the present embodiment includes: a feature extraction unit that extracts a feature of a person in a captured image captured by a camera; a first determination unit that determines, based on a feature extraction result, whether the person included in the captured image is a device user who uses an assistive device for assisting movement; a second determination unit that determines, based on the feature extraction result, whether an assistant who assists movement of the device user is present; and a control unit that switches between a first mode and a second mode that executes a process with a lower load than a processing load in the first mode depending on whether the assistant is present.

### CROSS-REFERENCE TO RELATED APPLICATION

This application claims priority to Japanese Patent Application No. 2022-078009 filed on May 11, 2022, incorporated herein by reference in its entirety.

### BACKGROUND

### 1. Technical Field

The present disclosure relates to a control system, a control method, and a storage medium.

### 2. Description of Related Art

Japanese Unexamined Patent Application Publication No. 2021-86199 (JP 2021-86199 A) discloses an autonomous mobile system equipped with a transport robot.

### SUMMARY

Such a transport robot is desired to perform transportation more efficiently. For example, when there are people around the transport robot, it is desirable to avoid the people when the transport robot moves. However, since it is difficult to improve human behavior, there are cases where appropriate control cannot be executed. For example, in a situation where people are around, it is necessary to move the transport robot at a low speed. Therefore, control for moving the transport robot more efficiently is desired.

The present disclosure has been made to solve the issue above, and provides a control system, a control method, and a storage medium capable of executing appropriate control depending on the situation.

A control system according to the present embodiment includes: a feature extraction unit that extracts a feature of a person in a captured image captured by a camera; a first determination unit that determines, based on a feature extraction result, whether the person included in the captured image is a device user who uses an assistive device for assisting movement; a second determination unit that determines, based on the feature extraction result, whether an assistant who assists movement of the device user is present; and a control unit that switches between a first mode and a second mode that executes a process with a lower load than a load in the first mode depending on whether the assistant is present.

The above control system may further include a classifier that classifies, using a machine learning model, the person included in the captured image into a first group and a second group set in advance.

In the above control system, a network layer of the machine learning model may be changed depending on a mode.

In the above control system, the number of pixels of an image captured by the camera, a frame rate of the camera, the number of used cores of a graphic processing unit, and an upper limit of a usage ratio of the graphic processing unit may be changed depending on a mode.

In the above control system, a server may collect images from a plurality of the cameras and execute a process in the first mode, and edge devices provided in the cameras alone may execute a process in the second mode.

The above control system may further include a mobile robot that moves autonomously in a facility, and control of the mobile robot may be switched depending on whether the assistant is present.

A control method according to the present embodiment includes: a step of extracting a feature of a person in a captured image captured by a camera; a step of determining, based on a feature extraction result, whether the person included in the captured image is a device user who uses an assistive device for assisting movement; a step of determining, based on the feature extraction result, whether an assistant who assists movement of the device user is present; and a step of switching between a first mode and a second mode that executes a process with a lower load than a load in the first mode depending on whether the assistant is present.

The above control method may further include a step of classifying, using a machine learning model, the person included in the captured image into a first group and a second group set in advance.

In the above control method, a network layer of the machine learning model may be changed depending on a mode.

In the above control method, the number of pixels of an image captured by the camera, a frame rate of the camera, the number of used cores of a graphic processing unit, and an upper limit of a usage ratio of the graphic processing unit may be changed depending on a mode.

In the above control method, a server may collect images from a plurality of the cameras and execute a process in the first mode, and edge devices provided in the cameras alone may execute a process in the second mode.

The above control method may further include a mobile robot that moves autonomously in a facility, and control of the mobile robot may be switched depending on whether the assistant is present.

A storage medium according to the present embodiment stores a program causing a computer to execute a control method. The control method includes: a step of extracting a feature of a person in a captured image captured by a camera; a step of determining, based on a feature extraction result, whether the person included in the captured image is a device user who uses an assistive device for assisting movement; a step of determining, based on the feature extraction result, whether an assistant who assists movement of the device user is present; and a step of switching between a first mode and a second mode that executes a process with a lower load than a load in the first mode depending on whether the assistant is present.

In the above storage medium, the control method may further include a step of classifying, using a machine learning model, the person included in the captured image into a first group and a second group set in advance.

In the above storage medium, a network layer of the machine learning model may be changed depending on a mode.

In the above storage medium, the number of pixels of an image captured by the camera, a frame rate of the camera, the number of used cores of a graphic processing unit, and an upper limit of a usage ratio of the graphic processing unit may be changed depending on a mode.

In the above storage medium, a server may collect images from a plurality of the cameras and execute a process in the first mode, and edge devices provided in the cameras alone may execute a process in the second mode.

The above storage medium may further include a mobile robot that moves autonomously in a facility, and control of the mobile robot may be switched depending on whether the assistant is present.

The present disclosure can provide a control system, a control method, and a storage medium capable of executing control more efficiently depending on the situation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an overall configuration of a system in which a mobile robot according to the present embodiment is used;

FIG. 2 is a control block diagram showing an example of a control system according to the present embodiment;

FIG. 3 is a schematic view showing an example of the mobile robot;

FIG. 4 is a control block diagram showing a control system for mode control;

FIG. 5 is a table for illustrating an example of mode information;

FIG. 6 is a flowchart showing a control method according to the present embodiment;

FIG. 7 is a control block diagram showing a control system for mode control according to a modification;

FIG. 8 is a table for illustrating an example of staff information;

FIG. 9 is a flowchart showing a control method according to the modification; and

FIG. 10 is a diagram for illustrating an example of the mode control.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

### Schematic Configuration

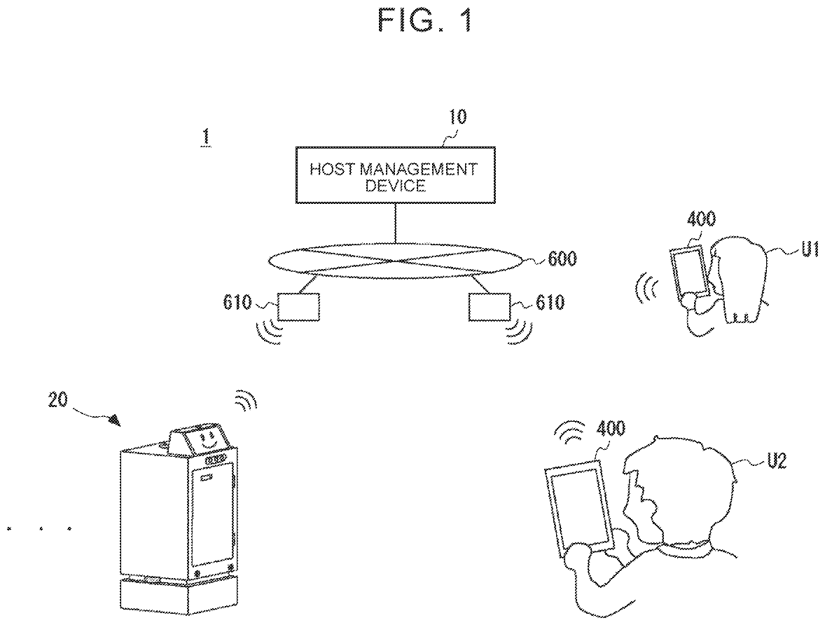

FIG. 1 is a conceptual diagram illustrating an overall configuration of a transport system 1 in which a mobile robot 20 according to the present embodiment is used. For example, the mobile robot 20 is a transport robot that executes transportation of a transported object as a task. The mobile robot 20 autonomously travels in order to transport a transported object in a medical welfare facility such as a hospital, a rehabilitation center, a nursing facility, and an elderly care facility. Moreover, the system according to the present embodiment can also be used in commercial facilities such as shopping malls.

A user U1 stores the transported object in the mobile robot 20 and requests transportation. The mobile robot 20 autonomously moves to the set destination to transport the transported object. That is, the mobile robot 20 executes a luggage transport task (hereinafter also simply referred to as a task). In the following description, the location where the transported object is loaded is referred to as a transport source, and the location where the transported object is delivered is referred to as a transport destination.

For example, it is assumed that the mobile robot 20 moves in a general hospital having a plurality of clinical departments. The mobile robot 20 transports equipment, consumables, medical equipment, and the like between the clinical departments. For example, the mobile robot delivers the transported object from a nurse station of one clinical department to a nurse station of another clinical department. Alternatively, the mobile robot delivers the transported object from the storage of the equipment and the medical equipment to the nurse station of the clinical department. Further, the mobile robot 20 also delivers medicine dispensed in the dispensing department to the clinical department or a patient that is scheduled to use the medicine.

Examples of the transported object include medicines, consumables such as bandages, specimens, testing instruments, medical equipment, hospital food, and equipment such as stationery. The medical equipment includes sphygmomanometers, blood transfusion pumps, syringe pumps, foot pumps, nurse call buttons, bed leaving sensors, low-pressure continuous inhalers, electrocardiogram monitors, drug injection controllers, enteral nutrition pumps, artificial respirators, cuff pressure gauges, touch sensors, aspirators, nebulizers, pulse oximeters, artificial resuscitators, aseptic devices, echo machines, and the like. Meals such as hospital food and inspection meals may also be transported. Further, the mobile robot 20 may transport used equipment, tableware that have been used during meals, and the like. When the transport destination is on a different floor, the mobile robot 20 may move using an elevator or the like.

The transport system 1 includes a mobile robot 20, a host management device 10, a network 600, communication units 610, and user terminals 400. The user U1 or the user U2 can make a transport request for the transported object using the user terminal 400. For example, the user terminal 400 is a tablet computer, smart phone, or the like. The user terminal 400 only needs to be an information processing device capable of wireless or wired communication.

In the present embodiment, the mobile robot 20 and the user terminals 400 are connected to the host management device 10 via the network 600. The mobile robot 20 and the user terminals 400 are connected to the network 600 via the communication units 610. The network 600 is a wired or wireless local area network (LAN) or wide area network (WAN). The host management device 10 is connected to the network 600 by wire or wirelessly. The communication unit 610 is, for example, a wireless LAN unit installed in each environment. The communication unit 610 may be a general-purpose communication device such as a WiFi router.

Various signals transmitted from the user terminals 400 of the users U1 and U2 are once sent to the host management device 10 via the network 600, and transmitted from the host management device 10 to the target mobile robot 20. Similarly, various signals transmitted from the mobile robot 20 are once sent to the host management device 10 via the network 600, and transmitted from the host management device 10 to the target user terminal 400. The host management device 10 is a server connected to each equipment, and collects data from each equipment. The host management device 10 is not limited to a physically single device, and may have a plurality of devices that performs distributed processing. Further, the host management device 10 may be distributedly provided in an edge device such as the mobile robot 20. For example, part of the transport system 1 or the entire transport system 1 may be installed in the mobile robot 20.

The user terminal 400 and the mobile robot 20 may transmit and receive signals without the host management device 10. For example, the user terminal 400 and the mobile robot 20 may directly transmit and receive signals by wireless communication. Alternatively, the user terminal 400 and the mobile robot 20 may transmit and receive signals via the communication unit 610.

The user U1 or the user U2 requests the transportation of the transported object using the user terminal 400. Hereinafter, the description is made assuming that the user U1 is the transport requester at the transport source and the user U2 is the planned recipient at the transport destination (destination). Needless to say, the user U2 at the transport destination can also make a transport request. Further, a user who is located at a location other than the transport source or the transport destination may make a transport request.

When the user U1 makes a transport request, the user U1 inputs, using the user terminal 400, the content of the transported object, the receiving point of the transported object (hereinafter also referred to as the transport source), the delivery destination of the transported object (hereinafter also referred to as the transport destination), the estimated arrival time at the transport source (the receiving time of the transported object), the estimated arrival time at the transport destination (the transport deadline), and the like. Hereinafter, these types of information are also referred to as transport request information. The user U1 can input the transport request information by operating the touch panel of the user terminal 400. The transport source may be a location where the user U1 is present, a storage location for the transported object, or the like. The transport destination is a location where the user U2 or a patient who is scheduled to use the transported object is present.

The user terminal 400 transmits the transport request information input by the user U1 to the host management device 10. The host management device 10 is a management system that manages a plurality of the mobile robots 20. The host management device 10 transmits an operation command for executing a transport task to the mobile robot 20. The host management device 10 determines the mobile robot 20 that executes the transport task for each transport request. The host management device 10 transmits a control signal including an operation command to the mobile robot 20. The mobile robot 20 moves from the transport source so as to arrive at the transport destination in accordance with the operation command.

For example, the host management device 10 assigns a transport task to the mobile robot 20 at or near the transport source. Alternatively, the host management device 10 assigns a transport task to the mobile robot 20 heading toward the transport source or its vicinity. The mobile robot 20 to which the task is assigned travels to the transport source to pick up the transported object. The transport source is, for example, a location where the user U1 who has requested the task is present.

When the mobile robot 20 arrives at the transport source, the user U1 or another staff member loads the transported object on the mobile robot 20. The mobile robot 20 on which the transported object is loaded autonomously moves with the transport destination set as the destination. The host management device 10 transmits a signal to the user terminal 400 of the user U2 at the transport destination. Thus, the user U2 can recognize that the transported object is being transported and the estimated arrival time. When the mobile robot 20 arrives at the set transport destination, the user U2 can receive the transported object stored in the mobile robot 20. As described above, the mobile robot 20 executes the transport task.

In the overall configuration described above, each element of the control system can be distributed to the mobile robot 20, the user terminal 400, and the host management device 10 to construct the control system as a whole. Further, it is possible to collect substantial elements for achieving the transportation of the transported object in a single device to construct the system. The host management device 10 controls one or more mobile robots 20.

The mobile robot 20 is, for example, an autonomous mobile robot that moves autonomously with reference to a map. The robot control system that controls the mobile robot 20 acquires distance information indicating the distance to a person measured using a ranging sensor. The robot control system estimates a movement vector indicating a moving speed and a moving direction of the person in accordance with a change of the distance to the person. The robot control system imposes a cost on the map to limit the movement of the mobile robot. The robot control system controls the mobile robot 20 to move corresponding to the cost updated in accordance with the measurement result of the ranging sensor. The robot control system may be installed in the mobile robot 20, or part of the robot control system or the entire robot control system may be installed in the host management device 10.

Further, facility users include staff members working at the facility and other non-staff persons. Here, when the facility is a hospital, the non-staff persons include patients, inpatients, visitors, outpatients, attendants, and the like. The staff members include doctors, nurses, pharmacists, clerks, occupational therapists, and other employees. Further, the staff members may also include people carrying various items, maintenance workers, cleaners, and the like. The staff members are not limited to direct employers or employees of the hospital, but may include affiliated employees.

The mobile robot 20 moves through a mixed environment under which both a hospital staff member and a non-staff person are present without coming into contact with these persons. Specifically, the mobile robot 20 moves at a speed at which the mobile robot 20 does not come into contact with people around the mobile robot 20, or further slows down or stops when an object is present closer than a preset distance. Further, the mobile robot 20 can also move autonomously to avoid objects, and emit sound and light to notify the surroundings of the presence of the mobile robot 20.

In order to properly control the mobile robot 20, the host management device 10 needs to monitor the facility appropriately in accordance with the condition of the facility. Specifically, the host management device 10 determines whether the user is a device user who uses an assistive device for assisting movement. The assistive device includes wheelchairs, crutches, canes, IV stands, and walkers. A user using the assistive device is also called the device user. Furthermore, the host management device 10 determines whether an assistant who assists movement is present around the device user. The assistant is a nurse, a family member, etc., who assist in movement of the device user.

For example, when the device user uses a wheelchair, the assistant pushes the wheelchair to assist in movement. Further, when the device user is using crutches, the assistant supports the weight of the device user and assists in movement. When no assistant is present around the device user, it is often difficult for the device user to move quickly. When the device user is moving alone, there is a possibility that the device user cannot change the direction quickly, and therefore there is a possibility that the device user performs an action that interferes with the task of the mobile robot.

When the device user is traveling alone, there is a need for more intensive monitoring of the area around the device user. Then, the host management device 10 controls the mobile robot 20 such that the mobile robot 20 does not approach the device user. The host management device 10 increases the processing load for monitoring. In other words, in an area where the device user is moving without the assistant, the host management device 10 executes a process in a first mode (high load mode) with a high processing load. Monitoring in the first mode makes it possible to accurately detect the position of the device user.

On the other hand, in an area where the device user is moving with the assistant, the host management device 10 executes a process in a second mode (low load mode) with a lower processing load than that of the first mode. That is, when the device user who is moving alone is not present, the host management device 10 executes a process in the second mode. When all the device users are moving together with the assistants, the host management device 10 reduces the processing load as compared with the first mode.

In the present embodiment, the host management device 10 determines whether the person captured by the camera is the device user (hereinafter also referred to as a first determination). Then, when the user is the device user, the host management device 10 determines whether there is the assistant who assists the movement of the device user (hereinafter also referred to as a second determination). For example, when there is another user near the device user, that user is determined as the assistant. Then, the host management device 10 changes the processing load based on the results of the first determination and the second determination.

In the area where the device user is moving without the assistant, the host management device 10 executes a process in the first mode with a high processing load. In the area where the device user is present but the device user who is moving without the assistant is not present, the host management device 10 executes a process in the second mode with a low processing load.

Accordingly, appropriate control can be executed in accordance with the usage status of the facility. That is, when the device user is traveling alone, more intensive monitoring is performed to reduce the impact on the task of the mobile robot 20. Accordingly, the transport task can be executed efficiently.

Furthermore, the facility may be divided into a plurality of monitoring target areas, and the mode may be switched for each monitoring target area. For example, in a monitoring target area where the device user who is moving alone is present, the host management device 10 performs monitoring in the high load mode. In a monitoring target area where the device user who is moving alone is not present, the host management device 10 performs monitoring in the low load mode. Accordingly, the transport task can be executed more efficiently. Further, when the area is divided into a plurality of monitoring target areas, the environmental camera 300 that monitors each monitoring target area may be assigned in advance. That is, the monitoring target area can be set in accordance with the imaging range of the environmental camera 300.

### Control Block Diagram

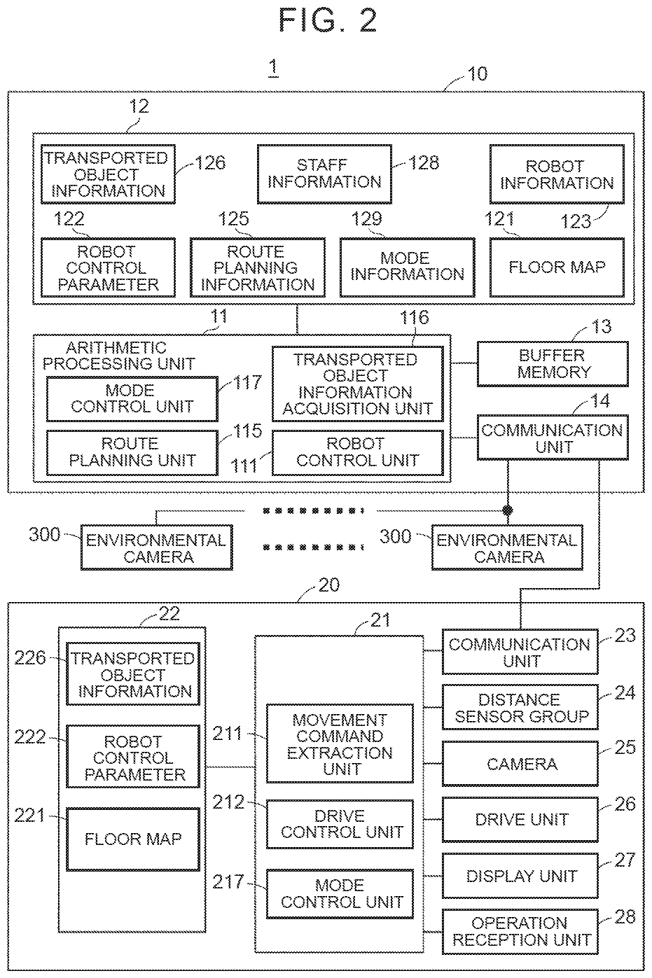

FIG. 2 shows a control block diagram showing a control system of the system 1. As shown in FIG. 2, the system 1 includes the host management device 10, the mobile robot 20, and the environmental cameras 300.

The system 1 efficiently controls a plurality of the mobile robots 20 while causing the mobile robots 20 to autonomously move in a predetermined facility. Therefore, a plurality of the environmental cameras 300 is installed in the facility. For example, the environmental cameras 300 are each installed in a passage, a hallway, an elevator, an entrance, etc. in the facility.

The environmental cameras 300 acquire images of ranges in which the mobile robot 20 moves. In the system 1, the host management device 10 collects the images acquired by the environmental cameras 300 and the information based on the images. Alternatively, the images or the like acquired by the environmental cameras 300 may be directly transmitted to the mobile robots. The environmental cameras 300 may be surveillance cameras or the like provided in a passage or an entrance/exit in the facility. The environmental cameras 300 may be used to determine the distribution of congestion status in the facility.

In the system 1 according to a first embodiment, the host management device 10 plans a route based on the transport request information. The host management device 10 instructs a destination for each mobile robot 20 based on the generated route planning information. Then, the mobile robot 20 autonomously moves toward the destination designated by the host management device 10. The mobile robot 20 autonomously moves toward the destination using sensors, floor maps, position information, and the like provided in the mobile robot 20 itself.

For example, the mobile robot 20 travels so as not to come into contact with surrounding equipment, objects, walls, and people (hereinafter collectively referred to as peripheral objects). Specifically, the mobile robot 20 detects the distance from the peripheral object and travels while keeping a distance from the peripheral object by a certain distance (defined as a distance threshold value) or more. When the distance from the peripheral object becomes equal to or less than the distance threshold value, the mobile robot 20 decelerates or stops. With this configuration, the mobile robot 20 can travel without coming into contact with the peripheral objects. Since contact can be avoided, safe and efficient transportation is possible.

The host management device 10 includes the arithmetic processing unit 11, a storage unit 12, a buffer memory 13, and a communication unit 14. The arithmetic processing unit 11 performs arithmetic for controlling and managing the mobile robot 20. The arithmetic processing unit 11 can be implemented as a device capable of executing a program such as a central processing unit (CPU) of a computer, for example. Various functions can also be realized by a program. Only a robot control unit 111, a route planning unit 115, and a transported object information acquisition unit 116 that are characteristics of the arithmetic processing unit 11 are shown in FIG. 2, but other processing blocks can also be provided.

The robot control unit 111 performs arithmetic for remotely controlling the mobile robot 20 and generates a control signal. The robot control unit 111 generates a control signal based on the route planning information 125 and the like. Further, the robot control unit 111 generates a control signal based on various types of information obtained from the environmental cameras 300 and the mobile robots 20. The control signal may include update information such as a floor map 121, robot information 123, and a robot control parameter 122. That is, when various types of information are updated, the robot control unit 111 generates a control signal in accordance with the updated information.

The transported object information acquisition unit 116 acquires information on the transported object. The transported object information acquisition unit 116 acquires information on the content (type) of the transported object that is being transported by the mobile robot 20. The transported object information acquisition unit 116 acquires transported object information relating to the transported object that is being transported by the mobile robot 20 in which an error has occurred.

The route planning unit 115 performs route planning for each mobile robot 20. When the transport task is input, the route planning unit 115 performs route planning for transporting the transported object to the transport destination (destination) based on the transport request information. Specifically, the route planning unit 115 refers to the route planning information 125, the robot information 123, and the like that are already stored in the storage unit 12, and determines the mobile robot 20 that executes the new transport task. The starting point is the current position of the mobile robot 20, the transport destination of the immediately preceding transport task, the receiving point of the transported object, or the like. The destination is the transport destination of the transported object, a standby location, a charging location, or the like.

Here, the route planning unit 115 sets passing points from the starting point to the destination of the mobile robot 20. The route planning unit 115 sets the passing order of the passing points for each mobile robot 20. The passing points are set, for example, at branch points, intersections, lobbies in front of elevators, and their surroundings. In a narrow passage, it may be difficult for the mobile robots 20 to pass each other. In such a case, the passing point may be set at a location before the narrow passage. Candidates for the passing points may be registered in the floor map 121 in advance.

The route planning unit 115 determines the mobile robot 20 that performs each transport task from among the mobile robots 20 such that the entire system can efficiently execute the task. The route planning unit 115 preferentially assigns the transport task to the mobile robot 20 on standby and the mobile robot 20 close to the transport source.

The route planning unit 115 sets passing points including the starting point and the destination for the mobile robot 20 to which the transport task is assigned. For example, when there are two or more movement routes from the transport source to the transport destination, the passing points are set such that the movement can be performed in a shorter time. Thus, the host management device 10 updates the information indicating the congestion status of the passages based on the images of the camera or the like. Specifically, locations where other mobile robots 20 are passing and locations with many people have a high degree of congestion. Therefore, the route planning unit 115 sets the passing points so as to avoid locations with a high degree of congestion.

The mobile robot 20 may be able to move to the destination by either a counterclockwise movement route or a clockwise movement route. In such a case, the route planning unit 115 sets the passing points so as to pass through the less congested movement route. The route planning unit 115 sets one or more passing points to the destination, whereby the mobile robot 20 can move along a movement route that is not congested. For example, when a passage is divided at a branch point or an intersection, the route planning unit 115 sets a passing point at the branch point, the intersection, the corner, and the surroundings as appropriate. Accordingly, the transport efficiency can be improved.

The route planning unit 115 may set the passing points in consideration of the congestion status of the elevator, the moving distance, and the like. Further, the host management device 10 may estimate the number of the mobile robots 20 and the number of people at the estimated time when the mobile robot 20 passes through a certain location. Then, the route planning unit 115 may set the passing points in accordance with the estimated congestion status. Further, the route planning unit 115 may dynamically change the passing points in accordance with a change in the congestion status. The route planning unit 115 sets the passing points sequentially for the mobile robot 20 to which the transport task is actually assigned. The passing points may include the transport source and the transport destination. The mobile robot 20 autonomously moves so as to sequentially pass through the passing points set by the route planning unit 115.

The mode control unit 117 executes control for switching modes in accordance with the condition of the facility. For example, the mode control unit 117 switches between the first mode and the second mode depending on the situation. The second mode is a low load mode in which the processing load of the processor or the like is low. The first mode is a high load mode in which the processing load of the processor or the like is high. In the first mode, the processing load on the processor or the like is higher than in the second mode. Therefore, switching the mode in accordance with the condition of the facility makes it possible to reduce the processing load and to reduce the power consumption. The control of the mode control unit 117 will be described later.

The storage unit 12 is a storage unit that stores information for managing and controlling the robot. In the example of FIG. 2, the floor map 121, the robot information 123, the robot control parameter 122, the route planning information 125, the transported object information 126, staff information 128, and mode information 129 are shown, but the information stored in the storage unit 12 may include other information. The arithmetic processing unit 11 performs arithmetic using the information stored in the storage unit 12 when performing various processes. Various types of information stored in the storage unit 12 can be updated to the latest information.

The floor map 121 is map information of a facility in which the mobile robot 20 moves. The floor map 121 may be created in advance, may be generated from information obtained from the mobile robot 20, or may be information obtained by adding map correction information that is generated from information obtained from the mobile robot 20, to a basic map created in advance.

For example, the floor map 121 stores the positions and information of walls, gates, doors, stairs, elevators, fixed shelves, etc. of the facility. The floor map 121 may be expressed as a two-dimensional grid map. In this case, in the floor map 121, information on walls and doors, for example, is attached to each grid.

The robot information 123 indicates the ID, model number, specifications, and the like of the mobile robot 20 managed by the host management device 10. The robot information 123 may include position information indicating the current position of the mobile robot 20. The robot information 123 may include information on whether the mobile robot 20 is executing a task or at standby. Further, the robot information 123 may also include information indicating whether the mobile robot 20 is operating, out-of-order, or the like. Still further, the robot information 123 may include information on the transported object that can be transported and the transported object that cannot be transported.

The robot control parameter 122 indicates control parameters such as a threshold distance from a peripheral object for the mobile robot 20 managed by the host management device 10. The threshold distance is a margin distance for avoiding contact with the peripheral objects including a person. Further, the robot control parameter 122 may include information on the operating intensity such as the speed upper limit value of the moving speed of the mobile robot 20.

The robot control parameter 122 may be updated depending on the situation. The robot control parameter 122 may include information indicating the availability and usage status of the storage space of a storage 291. The robot control parameter 122 may include information on a transported object that can be transported and a transported object that cannot be transported. The above-described various types of information in the robot control parameter 122 are associated with each mobile robot 20.

The route planning information 125 includes the route planning information planned by the route planning unit 115. The route planning information 125 includes, for example, information indicating a transport task. The route planning information 125 may include the ID of the mobile robot 20 to which the task is assigned, the starting point, the content of the transported object, the transport destination, the transport source, the estimated arrival time at the transport destination, the estimated arrival time at the transport source, the arrival deadline, and the like. In the route planning information 125, the various types of information described above may be associated with each transport task. The route planning information 125 may include at least part of the transport request information input from the user U1.

Further, the route planning information 125 may include information on the passing points for each mobile robot 20 and each transport task. For example, the route planning information 125 includes information indicating the passing order of the passing points for each mobile robot 20. The route planning information 125 may include the coordinates of each passing point on the floor map 121 and information on whether the mobile robot 20 has passed the passing points.

The transported object information 126 is information on the transported object for which the transport request has been made. For example, the transported object information 126 includes information such as the content (type) of the transported object, the transport source, and the transport destination. The transported object information 126 may include the ID of the mobile robot 20 in charge of the transportation. Further, the transported object information 126 may include information indicating the status such as transport under way, pre-transport (before loading), and post-transport. These types of information in the transported object information 126 are associated with each transported object.

The staff information 128 is information for classifying whether a user of the facility is a staff member. That is, the staff information 128 includes information for classifying persons included in image data into the first group or the second group. For example, the staff information 128 includes information on the staff members registered in advance. The staff information will be described in detail in a modification. The mode information 129 includes information for controlling each mode based on the determination result. Details of the mode information 129 will be described later.

The route planning unit 115 refers to various types of information stored in the storage unit 12 to formulate a route plan. For example, the route planning unit 115 determines the mobile robot 20 that executes the task, based on the floor map 121, the robot information 123, the robot control parameter 122, and the route planning information 125. Then, the route planning unit 115 refers to the floor map 121 and the like to set the passing points to the transport destination and the passing order thereof. Candidates for the passing points are registered in the floor map 121 in advance. The route planning unit 115 sets the passing points in accordance with the congestion status and the like. In the case of continuous processing of tasks, the route planning unit 115 may set the transport source and the transport destination as the passing points.

Two or more of the mobile robots 20 may be assigned to one transport task. For example, when the transported object is larger than the transportable capacity of the mobile robot 20, one transported object is divided into two and loaded on the two mobile robots 20. Alternatively, when the transported object is heavier than the transportable weight of the mobile robot 20, one transported object is divided into two and loaded on the two mobile robots 20. With this configuration, one transport task can be shared and executed by two or more mobile robots 20. It goes without saying that, when the mobile robots 20 of different sizes are controlled, route planning may be performed such that the mobile robot 20 capable of transporting the transported object receives the transported object.

Further, one mobile robot 20 may perform two or more transport tasks in parallel. For example, one mobile robot 20 may simultaneously load two or more transported objects and sequentially transport the transported objects to different transport destinations. Alternatively, while one mobile robot 20 is transporting one transported object, another transported object may be loaded on the mobile robot 20. The transport destinations of the transported objects loaded at different locations may be the same or different. With this configuration, the tasks can be executed efficiently.

In such a case, storage information indicating the usage status or the availability of the storage space of the mobile robot 20 may be updated. That is, the host management device 10 may manage the storage information indicating the availability and control the mobile robot 20. For example, the storage information is updated when the transported object is loaded or received. When the transport task is input, the host management device 10 refers to the storage information and directs the mobile robot 20 having room for loading the transported object to receive the transported object. With this configuration, one mobile robot 20 can execute a plurality of transport tasks at the same time, and two or more mobile robots 20 can share and execute the transport tasks. For example, a sensor may be installed in the storage space of the mobile robot 20 to detect the availability. Further, the capacity and weight of each transported object may be registered in advance.

The buffer memory 13 is a memory that stores intermediate information generated in the processing of the arithmetic processing unit 11. The communication unit 14 is a communication interface for communicating with the environmental cameras 300 provided in the facility where the system 1 is used, and at least one mobile robot 20. The communication unit 14 can perform both wired communication and wireless communication. For example, the communication unit 14 transmits a control signal for controlling each mobile robot 20 to each mobile robot 20. The communication unit 14 receives the information collected by the mobile robot 20 and the environmental cameras 300.

The mobile robot 20 includes an arithmetic processing unit 21, a storage unit 22, a communication unit 23, a proximity sensor (for example, a distance sensor group 24), cameras 25, a drive unit 26, a display unit 27, and an operation reception unit 28. Although FIG. 2 shows only typical processing blocks provided in the mobile robot 20, the mobile robot 20 also includes many other processing blocks that are not shown.

The communication unit 23 is a communication interface for communicating with the communication unit 14 of the host management device 10. The communication unit 23 communicates with the communication unit 14 using, for example, a wireless signal. The distance sensor group 24 is, for example, a proximity sensor, and outputs proximity object distance information indicating a distance from an object or a person that is present around the mobile robot 20. The distance sensor group 24 has a range sensor such as a LIDAR. Manipulating the emission direction of the optical signal makes it possible to measure the distance to the peripheral object. Also, the peripheral objects may be recognized from point cloud data detected by the ranging sensor or the like. The camera 25, for example, captures an image for grasping the surrounding situation of the mobile robot 20. The camera 25 can also capture an image of a position marker provided on the ceiling or the like of the facility, for example. The mobile robot 20 may be made to grasp the position of the mobile robot 20 itself using this position marker.

The drive unit 26 drives drive wheels provided on the mobile robot 20. Note that, the drive unit 26 may include an encoder or the like that detects the number of rotations of the drive wheels and the drive motor thereof. The position of the mobile robot 20 (current position) may be estimated based on the output of the above encoder. The mobile robot 20 detects its current position and transmits the information to the host management device 10. The mobile robot 20 estimates its own position on the floor map 121 by odometry or the like.

The display unit 27 and the operation reception unit 28 are realized by a touch panel display. The display unit 27 displays a user interface screen that serves as the operation reception unit 28. Further, the display unit 27 may display information indicating the destination of the mobile robot 20 and the state of the mobile robot 20. The operation reception unit 28 receives an operation from the user. The operation reception unit 28 includes various switches provided on the mobile robot 20 in addition to the user interface screen displayed on the display unit 27.

The arithmetic processing unit 21 performs arithmetic used for controlling the mobile robot 20. The arithmetic processing unit 21 can be implemented as a device capable of executing a program such as a central processing unit (CPU) of a computer, for example. Various functions can also be realized by a program. The arithmetic processing unit 21 includes a movement command extraction unit 211, a drive control unit 212, and a mode control unit 217. Although FIG. 2 shows only typical processing blocks included in the arithmetic processing unit 21, the arithmetic processing unit 21 includes processing blocks that are not shown. The arithmetic processing unit 21 may search for a route between the passing points.

The movement command extraction unit 211 extracts a movement command from the control signal given by the host management device 10. For example, the movement command includes information on the next passing point. For example, the control signal may include information on the coordinates of the passing points and the passing order of the passing points. The movement command extraction unit 211 extracts these types of information as a movement command.

Further, the movement command may include information indicating that the movement to the next passing point has become possible. When the passage width is narrow, the mobile robots 20 may not be able to pass each other. There are also cases where the passage cannot be used temporarily. In such a case, the control signal includes a command to stop the mobile robot 20 at a passing point before the location at which the mobile robot 20 should stop. After the other mobile robot 20 has passed or after movement in the passage has become possible, the host management device 10 outputs a control signal informing the mobile robot 20 that the mobile robot 20 can move in the passage. Thus, the mobile robot 20 that has been temporarily stopped resumes movement.

The drive control unit 212 controls the drive unit 26 such that the drive unit 26 moves the mobile robot 20 based on the movement command given from the movement command extraction unit 211. For example, the drive unit 26 includes drive wheels that rotate in accordance with a control command value from the drive control unit 212. The movement command extraction unit 211 extracts the movement command such that the mobile robot 20 moves toward the passing point received from the host management device 10. The drive unit 26 rotationally drives the drive wheels. The mobile robot 20 autonomously moves toward the next passing point. With this configuration, the mobile robot 20 sequentially passes the passing points and arrives at the transport destination. Further, the mobile robot 20 may estimate its position and transmit a signal indicating that the mobile robot 20 has passed the passing point to the host management device 10. Thus, the host management device 10 can manage the current position and the transportation status of each mobile robot 20.

The mode control unit 217 executes control for switching modes depending on the situation. The mode control unit 217 may execute the same process as the mode control unit 117. Part of the process of the mode control unit 117 of the host management device 10 may be executed. That is, the mode control unit 117 and the mode control unit 217 may operate together to execute the process for controlling the mode. Further, the process may be executed independently of the mode control unit 117. The mode control unit 217 executes a process with a lower processing load than that of the mode control unit 117.

The storage unit 22 stores a floor map 221, a robot control parameter 222, and transported object information 226. FIG. 2 shows part of the information stored in the storage unit 22, including information other than the floor map 221, the robot control parameter 222, and the transported object information 226 shown in FIG. 2. The floor map 221 is map information of a facility in which the mobile robot 20 moves. This floor map 221 is, for example, a download of the floor map 121 of the host management device 10. Note that the floor map 221 may be created in advance. Further, the floor map 221 may not be the map information of the entire facility but may be the map information including part of the area in which the mobile robot 20 is scheduled to move.

The robot control parameter 222 is a parameter for operating the mobile robot 20. The robot control parameter 222 includes, for example, the distance threshold value from a peripheral object. Further, the robot control parameter 222 also includes a speed upper limit value of the mobile robot 20.

Similar to the transported object information 126, the transported object information 226 includes information on the transported object. The transported object information 226 includes information such as the content (type) of the transported object, the transport source, and the transport destination. The transported object information 226 may include information indicating the status such as transport under way, pre-transport (before loading), and post-transport. These types of information in the transported object information 226 are associated with each transported object. The details of the transported object information 226 will be described later. The transported object information 226 only needs to include information on the transported object transported by the mobile robot 20. Therefore, the transported object information 226 is part of the transported object information 126. That is, the transported object information 226 does not have to include the information on the transportation performed by other mobile robots 20.

The drive control unit 212 refers to the robot control parameter 222 and stops the operation or decelerates in response to the fact that the distance indicated by the distance information obtained from the distance sensor group 24 has fallen below the distance threshold value. The drive control unit 212 controls the drive unit 26 such that the mobile robot 20 travels at a speed equal to or lower than the speed upper limit value. The drive control unit 212 limits the rotation speed of the drive wheels such that the mobile robot 20 does not move at a speed equal to or higher than the speed upper limit value.

### Configuration of Mobile Robot 20

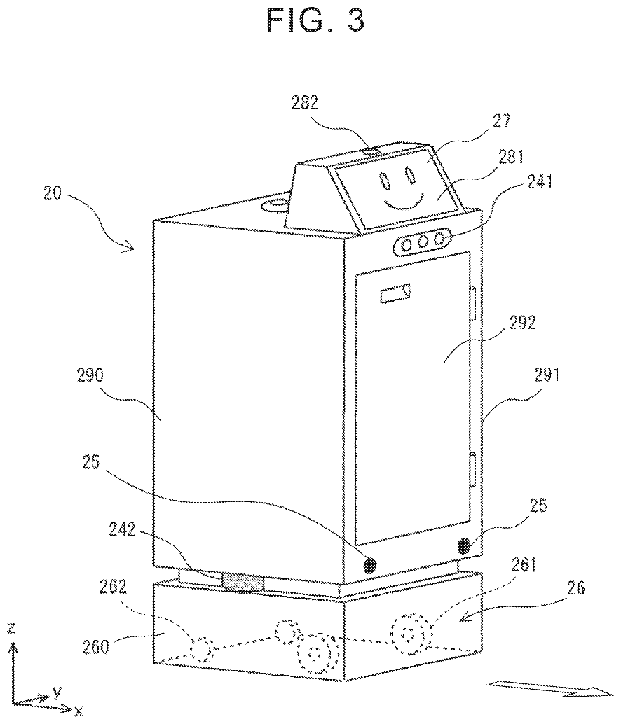

Here, the appearance of the mobile robot 20 will be described. FIG. 3 shows a schematic view of the mobile robot 20. The mobile robot 20 shown in FIG. 3 is one of the modes of the mobile robot 20, and may be in another form. In FIG. 3, the x direction is the forward and backward directions of the mobile robot 20, the y direction is the right-left direction of the mobile robot 20, and the z direction is the height direction of the mobile robot 20.

The mobile robot 20 includes a main body portion 290 and a carriage portion 260. The main body portion 290 is installed on the carriage portion 260. The main body portion 290 and the carriage portion 260 each have a rectangular parallelepiped housing, and each component is installed inside the housing. For example, the drive unit 26 is housed inside the carriage portion 260.

The main body portion 290 is provided with the storage 291 that serves as a storage space and a door 292 that seals the storage 291. The storage 291 is provided with a plurality of shelves, and the availability is managed for each shelf. For example, by providing various sensors such as a weight sensor in each shelf, the availability can be updated. The mobile robot 20 moves autonomously to transport the transported object stored in the storage 291 to the destination instructed by the host management device 10. The main body portion 290 may include a control box or the like (not shown) in the housing. Further, the door 292 may be able to be locked with an electronic key or the like. Upon arriving at the transport destination, the user U2 unlocks the door 292 with the electronic key. Alternatively, the door 292 may be automatically unlocked when the mobile robot 20 arrives at the transport destination.

As shown in FIG. 3, front-rear distance sensors 241 and right-left distance sensors 242 are provided as the distance sensor group 24 on the exterior of the mobile robot 20. The mobile robot 20 measures the distance of the peripheral objects in the front-rear direction of the mobile robot 20 by the front-rear distance sensors 241. The mobile robot 20 measures the distance of the peripheral objects in the right-left direction of the mobile robot 20 by the right-left distance sensors 242.

For example, the front-rear distance sensor 241 is provided on the front surface and the rear surface of the housing of the main body portion 290. The right-left distance sensor 242 is provided on the left side surface and the right side surface of the housing of the main body portion 290. The front-rear distance sensors 241 and the right-left distance sensors 242 are, for example, ultrasonic distance sensors and laser rangefinders. The front-rear distance sensors 241 and the right-left distance sensors 242 detect the distance from the peripheral objects. When the distance from the peripheral object detected by the front-rear distance sensor 241 or the right-left distance sensor 242 becomes equal to or less than the distance threshold value, the mobile robot 20 decelerates or stops.

The drive unit 26 is provided with drive wheels 261 and casters 262. The drive wheels 261 are wheels for moving the mobile robot 20 frontward, rearward, rightward, and leftward. The casters 262 are driven wheels that roll following the drive wheels 261 without being given a driving force. The drive unit 26 includes a drive motor (not shown) and drives the drive wheels 261.

For example, the drive unit 26 supports, in the housing, two drive wheels 261 and two casters 262, each of which are in contact with the traveling surface. The two drive wheels 261 are arranged such that their rotation axes coincide with each other. Each drive wheel 261 is independently rotationally driven by a motor (not shown). The drive wheels 261 rotate in accordance with a control command value from the drive control unit 212 in FIG. 2. The casters 262 are driven wheels that are provided such that a pivot axis extending in the vertical direction from the drive unit 26 pivotally supports the wheels at a position away from the rotation axis of the wheels, and thus follow the movement direction of the drive unit 26.

For example, when the two drive wheels 261 are rotated in the same direction at the same rotation speed, the mobile robot 20 travels straight, and when the two drive wheels 261 are rotated at the same rotation speed in the opposite directions, the mobile robot 20 pivots around the vertical axis extending through approximately the center of the two drive wheels 261. Further, by rotating the two drive wheels 261 in the same direction and at different rotation speeds, the mobile robot 20 can proceed while turning right and left. For example, by making the rotation speed of the left drive wheel 261 higher than the rotation speed of the right drive wheel 261, the mobile robot 20 can make a right turn. In contrast, by making the rotation speed of the right drive wheel 261 higher than the rotation speed of the left drive wheel 261, the mobile robot 20 can make a left turn. That is, the mobile robot 20 can travel straight, pivot, turn right and left, etc. in any direction by controlling the rotation direction and the rotation speed of each of the two drive wheels 261.

Further, in the mobile robot 20, the display unit 27 and an operation interface 281 are provided on the upper surface of the main body portion 290. The operation interface 281 is displayed on the display unit 27. When the user touches and operates the operation interface 281 displayed on the display unit 27, the operation reception unit 28 can receive an instruction input from the user. An emergency stop button 282 is provided on the upper surface of the display unit 27. The emergency stop button 282 and the operation interface 281 function as the operation reception unit 28.

The display unit 27 is, for example, a liquid crystal panel that displays a character's face as an illustration or presents information on the mobile robot 20 in text or with an icon. By displaying a character's face on the display unit 27, it is possible to give surrounding observers the impression that the display unit 27 is a pseudo face portion. It is also possible to use the display unit 27 or the like installed in the mobile robot 20 as the user terminal 400.

The cameras 25 are installed on the front surface of the main body portion 290. Here, the two cameras 25 function as stereo cameras. That is, the two cameras 25 having the same angle of view are provided so as to be horizontally separated from each other. An image captured by each camera 25 is output as image data. It is possible to calculate the distance from the subject and the size of the subject based on the image data of the two cameras 25. The arithmetic processing unit 21 can detect a person, an obstacle, or the like at positions forward in the movement direction by analyzing the images of the cameras 25. When there are people or obstacles at positions forward in the traveling direction, the mobile robot 20 moves along the route while avoiding the people or the obstacles. Further, the image data of the cameras 25 is transmitted to the host management device 10.

The mobile robot 20 recognizes the peripheral objects and identifies the position of the mobile robot 20 itself by analyzing the image data output by the cameras 25 and the detection signals output by the front-rear distance sensors 241 and the right-left distance sensors 242. The cameras 25 capture images of the front of the mobile robot 20 in the traveling direction. As shown in FIG. 3, the mobile robot 20 has the side on which the cameras 25 are installed as the front of the mobile robot 20. That is, during normal movement, the traveling direction is the forward direction of the mobile robot 20 as shown by the arrow.

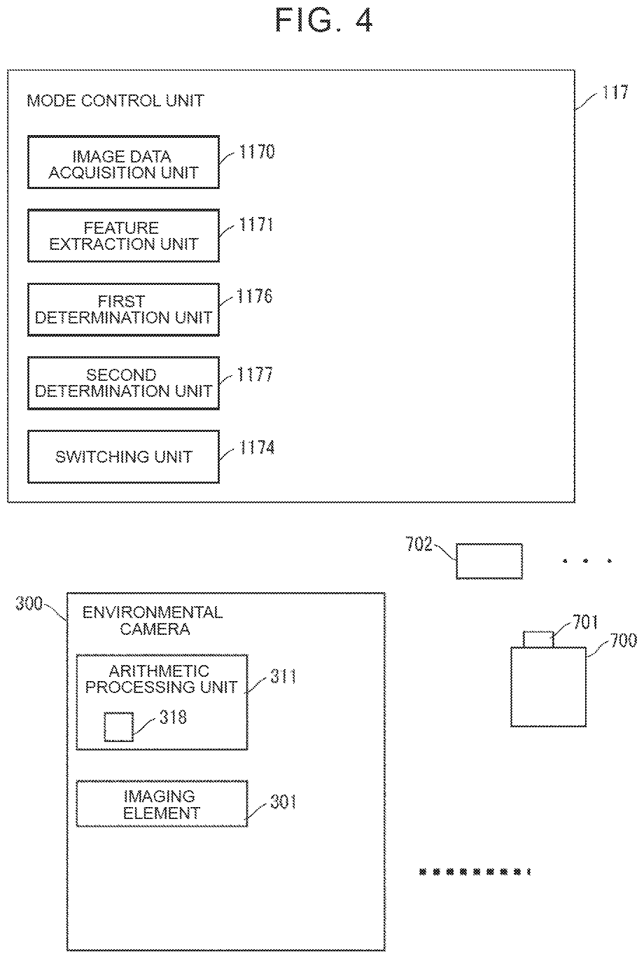

Next, a mode control process will be described with reference to FIG. 4. Here, a description will be made on assumption that the host management device 10 executes the process for mode control. Therefore, FIG. 4 is a block diagram mainly showing the control system of the mode control unit 117. As a matter of course, the mode control unit 217 of the mobile robot 20 may execute at least part of the processes of the mode control unit 117. That is, the mode control unit 217 and the mode control unit 117 may operate together to execute the mode control process. Alternatively, the mode control unit 217 may execute the mode control process. Alternatively, the environmental cameras 300 may execute at least part of the processes for mode control.

The mode control unit 117 includes an image data acquisition unit 1170, a feature extraction unit 1171, a switching unit 1174, a first determination unit 1176, and a second determination unit 1177. Each environmental camera 300 includes an imaging element 301 and an arithmetic processing unit 311. The imaging element 301 captures an image for monitoring the inside of the facility. The arithmetic processing unit 311 includes a graphic processing unit (GPU) 318 that executes image processing on an image captured by the imaging element 301. An assistive device 700 includes wheelchairs, crutches, canes, IV stands, and walkers, as described above.

The image data acquisition unit 1170 acquires image data of images captured by the environmental camera 300. Here, the image data may be imaged data itself captured by the environmental camera 300, or may be data obtained by processing the imaged data. For example, the image data may be feature amount data extracted from the imaged data. Further, the image data may be added with information such as the imaging time and the imaging location. Further, the image data acquisition unit 1170 may acquire image data from the camera 25 of the mobile robot 20, in addition to the environmental camera 300. That is, the image data acquisition unit 1170 may acquire the image data based on images captured by the camera 25 provided on the mobile robot 20. The image data acquisition unit 1170 may acquire the image data from multiple environmental cameras 300.

The feature extraction unit 1171 extracts the features of the person in the captured images. More specifically, the feature extraction unit 1171 detects a person included in the image data by executing image processing on the image data. Then, the feature extraction unit 1171 extracts the features of the person included in the image data. Further, an arithmetic processing unit 311 provided in the environmental camera 300 may execute at least part of the process for extracting the feature amount. Note that, as the means for detecting that a person is included in the image data, various techniques such as a Histograms of Oriented Gradients (HOG) feature amount and machine learning including convolution processing are known to those skilled in the art. Therefore, detailed description will be omitted here.

The first determination unit 1176 determines whether the person included in the image data is the device user who uses the assistive device 700 based on the feature extraction result. A determination by the first determination unit 1176 is referred to as a first determination. The assistive device includes wheelchairs, crutches, canes, IV stands, walkers, and the like. Since each assistive device has a different shape, each assistive device has a different feature amount vector. Therefore, it is possible to determine whether there is the assistive device by comparing the feature amounts. The first determination unit 1176 can determine whether the person is the device user using the feature amount obtained by the image processing.

Further, the first determination unit 1176 may use a machine learning model to perform the first determination. For example, a machine learning model for the first determination can be built in advance by supervised learning. That is, the image can be used as learning data for supervised learning by attaching the presence or absence of the assistive device to the captured image as a correct answer label. Deep learning is performed with the presence or absence of the assistive device as the correct answer level. A captured image including the device user can be used as learning data for supervised learning. Similarly, a captured image including a non-device user who does not use the assistive device can be used as learning data for supervised learning. With this configuration, it is possible to generate a machine learning model capable of accurately performing the first determination from the image data.

The second determination unit 1177 determines whether the person included in the image data is the assistant who assists the device user based on the feature extraction result. A determination by the second determination unit 1177 is referred to as a second determination. For example, when there is a person behind the device user who uses a wheelchair, the second determination unit 1177 determines that person as the assistant. The second determination unit 1177 determines that the person behind the wheelchair is the assistant pushing the wheelchair. In addition, when there is a person next to the device user who uses a crutch, cane, drip stand, or the like, the second determination unit 1177 determines that the person as the assistant. The second determination unit 1177 determines that the person next to the device user is the assistant supporting the weight of the device user.

For example, the second determination unit 1177 may determine that the assistant is present when a person is present near the device user. The second determination unit 1177 can determine that the person around the device user is the assistant. The second determination unit 1177 can make the second determination in accordance with the relative distance and the relative position between the device user and the person present around the device user.

Alternatively, the second determination unit 1177 may use a machine learning model to perform the second determination. For example, a machine learning model for the second determination can be built in advance by supervised learning. The image can be used as learning data for supervised learning by attaching the presence or absence of the assistant to the captured image as a correct answer label. Deep learning is performed with the presence or absence of the assistant as the correct answer level. A captured image including the assistant and the device user can be used as learning data for supervised learning. Similarly, a captured image including the device user only can be used as learning data for supervised learning. That is, a captured image not including the assistant but including the device user can be used as learning data for supervised learning. With this configuration, it is possible to generate a machine learning model capable of accurately performing the second determination from the image data.

Further, the first determination unit 1176 and the second determination unit 1177 may perform determination using a common machine learning model. That is, one machine learning model may perform the first determination and the second determination. With this configuration, a single machine learning model can determine whether there is the device user and whether there is the assistant accompanying the device user. Further, a machine learning model may perform feature extraction. In this case, the machine learning model receives the captured image as input and outputs the determination result.

The switching unit 1174 switches between the first mode (high load mode) for high load processing and the second mode (low load mode) for low load processing based on the results of the first determination and the second determination. Specifically, the switching unit 1174 sets the area where the assistant is not present and where the device user is present to the first mode. The switching unit 1174 switches the mode to the second mode in areas where the assistant and the device user are present. That is, the switching unit 1174 switches the mode to the second mode when all the device users are accompanied by the assistants. The switching unit 1174 switches the mode to the second mode in areas where there are no device users at all. The switching unit 1174 outputs a signal for switching the mode to the edge device. The edge device includes, for example, one or more of the environmental camera 300, the mobile robot 20, the communication unit 610, and the user terminal 400.

Further, the assistive device 700 may be provided with a tag 701. The tag 701 is a wireless tag such as a radiofrequency identifier (RFID) and performs wireless communication with a tag reader 702. With this configuration, the tag reader 702 can read ID information and the like of the tag 701. The first determination unit 1176 may perform the first determination based on the reading result of the tag reader 702.

For example, a plurality of the tag readers 702 is disposed in passages or rooms. The tag 701 storing unique information is attached to each assistive device 700. When the tag reader 702 can read the information from the tag 701, the presence of the assistive device 700 around the tag reader 702 can be detected. For example, there is a distance at which wireless communication is possible between the tag reader 702 and the tag 701. When the tag reader 702 can read the information from the tag 701, the presence of the assistive device 700 within the communicable range from the tag reader 702 can be detected. That is, since the position of the assistive device 700 to which the tag 701 is attached can be specified, it is possible to determine whether the device user is present.

With this configuration, the first determination unit 1176 can accurately determine whether the device user is present. For example, when the assistive device 700 is located in the blind spot of the environmental camera 300, it becomes difficult to determine whether there is the assistive device from the captured image. In such a case, the first determination unit 1176 can determine the person near the tag 701 as the device user. Alternatively, when the tag reader 702 does not read the information of the tag 701, the first determination unit 1176 may erroneously determine that the device user is present. Even in such a case, the first determination unit 1176 performs the first determination based on the tag 701. With this configuration, whether the device user is present can be accurately determined.

### Mode Information

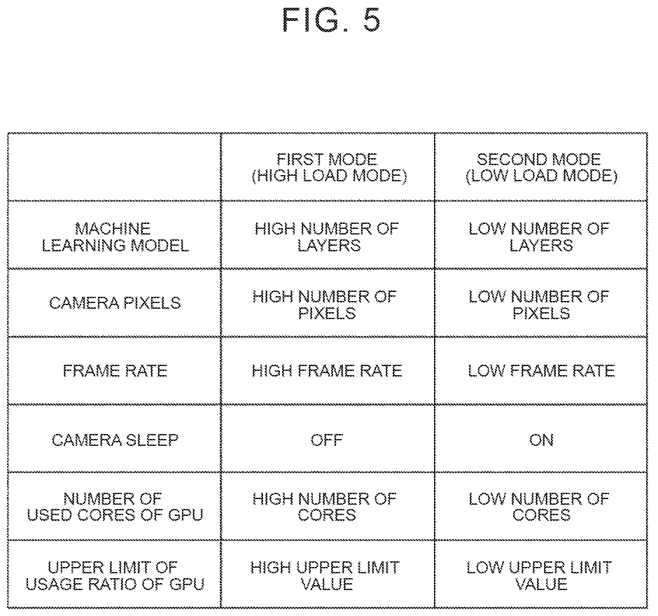

FIG. 5 is a table showing an example of the mode information 129. FIG. 5 shows a difference in processing between the first mode (high load mode) and the second mode (low load mode). In FIG. 5, six items of the machine learning model, the camera pixel, the frame rate, the camera sleep, the number of used cores of the GPU, and the upper limit of a GPU usage ratio are shown as target items of the mode control. The switching unit 1174 can switch one or more items shown in FIG. 5 in accordance with the mode.

As shown in the item of the machine learning model, the switching unit 1174 switches the machine learning models of the first determination unit 1176 and the second determination unit 1177. It is assumed that the first determination unit 1176 and the second determination unit 1177 are machine learning models having multiple layers of Deep Neural Network (DNN). In the low load mode, the first determination unit 1176 and the second determination unit 1177 executes the determination process using the machine learning model with a low number of layers. Accordingly, the processing load can be reduced.

In the high load mode, the first determination unit 1176 and the second determination unit 1177 execute the determination process using the machine learning model with a high number of layers. Accordingly, it is possible to improve the determination accuracy in the high load mode. The machine learning model with a high number of layers has a higher computational load than the machine learning model with a low number of layers. Therefore, the switching unit 1174 switches the network layer of the machine learning model of the first determination unit 1176 and the second determination unit 1177 in accordance with the mode, whereby the calculation load can be changed.

The machine learning model with a low number of layers may be a machine learning model in which the probability that the assistant is present is low, as compared with the machine learning model with a high number of layers. Therefore, when a determination is made that the assistant is not present from the output result of the machine learning model with a low number of layers, the switching unit 1174 switches from the low load mode to the high load mode. The switching unit 1174 can appropriately switch from the low load mode to the high load mode. The edge devices such as the environmental cameras 300 and the mobile robot 20 may implement the machine learning model with a low number of network layers. In this case, the edge device alone can execute processes such as determination, classification, or switching. On the other hand, the host management device 10 may implement the machine learning model with a high number of network layers.

Alternatively, the switching unit 1174 may switch the machine learning model of only one of the first determination unit 1176 and the second determination unit 1177. As a matter of course, only one of the first determination unit 1176 and the second determination unit 1177 may perform determination using the machine learning model. In other words, the other of the first determination unit 1176 and the second determination unit 1177 may not use the machine learning model. Further, the switching unit 1174 may switch the machine learning model of the classifier shown in a modification.

As shown in the camera pixel item, the switching unit 1174 switches the number of pixels of the environmental camera 300. In the low load mode, the environmental camera 300 outputs captured images with a low number of pixels. In the high load mode, the environmental camera 300 outputs captured images with a high number of pixels. That is, the switching unit 1174 outputs a control signal for switching the number of pixels of the captured images by the environmental camera 300. When the captured image with a high number of pixels is used, the processing load on the processor or the like is higher than when the captured image with a low number of pixels is used. The environmental camera 300 may be provided with a plurality of imaging elements with different numbers of pixels so as to switch the number of pixels of the environmental camera 300. Alternatively, a program or the like installed in the environmental camera 300 may output captured images having different numbers of pixels. For example, the GPU 318 or the like thins out the image data of the captured image with a high number of pixels, whereby the captured image with a low number of pixels can be generated.

In the low load mode, the feature extraction unit 1171 extracts features based on the captured image with a low number of pixels. Further, in the low load mode, the first determination unit 1176 and the second determination unit 1177 perform determinations based on the captured image with a low number of pixels. Accordingly, the processing load can be reduced. In the high load mode, the feature extraction unit 1171 extracts features based on the captured image with a high number of pixels. In the high load mode, the first determination unit 1176 and the second determination unit 1177 perform determinations based on the captured image with a high number of pixels. Accordingly, it is possible to improve the determination accuracy in the high load mode. Therefore, it is possible to effectively monitor the device user who moves without the assistant, whereby appropriate control can be executed.

As shown in the frame rate item, the switching unit 1174 switches the frame rate of the environmental camera 300. In the low load mode, the environmental camera 300 captures images at a low frame rate. In the high load mode, the environmental camera 300 captures images at a high frame rate. That is, the switching unit 1174 outputs a control signal for switching the frame rate of the image captured by the environmental camera 300 in accordance with the mode. The images are captured at a high frame rate, and therefore the processing load on the processor or the like becomes higher than that when the frame rate is low.

Therefore, in the high load mode, the feature extraction unit 1171 extracts features based on the captured image at a high frame rate. Further, in the low load mode, the first determination unit 1176 and the second determination unit 1177 perform determinations based on the captured image at a low frame rate. Accordingly, the processing load can be reduced. In the high load mode, the feature extraction unit 1171 extracts features based on the captured image at a high frame rate. In the high load mode, the first determination unit 1176 and the second determination unit 1177 perform determinations based on the captured image at a high frame rate. Accordingly, it is possible to improve the determination accuracy in the high load mode. Therefore, it is possible to effectively monitor the device user who moves without the assistant, whereby appropriate control can be executed.

As shown in the camera sleep item, the switching unit 1174 switches ON/OFF of the sleep of the environmental camera 300. In the low load mode, the environmental camera 300 is put to a sleep state. In the high load mode, the environmental camera 300 operates without sleeping. That is, the switching unit 1174 outputs a control signal for switching ON/OFF of the sleep of the environmental camera 300 in accordance with the mode. In the low load mode, the environmental camera 300 is put to sleep, whereby the processing load is reduced and the power consumption can thus be reduced.

As shown in the item of the number of used cores of the GPU, the switching unit 1174 switches the number of used cores of the GPU 318. The GPU 318 executes image processing on the image captured by the environmental camera. For example, as shown in FIG. 4, each environmental camera 300 functions as an edge device provided with the arithmetic processing unit 311. The arithmetic processing unit 311 includes the GPU 318 for executing image processing. The GPU 318 includes multiple cores capable of parallel processing.

In the low load mode, the GPU 318 of each environmental camera 300 operates with a low number of cores. Accordingly, the load of the arithmetic processing can be reduced. In the high load mode, the GPU 318 of each environmental camera 300 operates with a high number of cores. That is, the switching unit 1174 outputs a control signal for switching the number of cores of the GPU 318 in accordance with the mode. When the number of cores is high, the processing load on the environmental camera 300 that is the edge device becomes high.

Therefore, in the low load mode, the feature extraction, the determination process, and the like are executed by the GPU 318 with a low number of cores. In the high load mode, the feature extraction of the user and the determination process are executed by the GPU 318 with a high number of cores. Accordingly, it is possible to improve the determination accuracy in the high load mode. Therefore, it is possible to effectively monitor the device user who moves without the assistant, whereby appropriate control can be executed.

As shown in the item of the upper limit of the GPU usage ratio, the switching unit 1174 switches the upper limit of the GPU usage ratio. The GPU 318 executes image processing on the image captured by the environmental camera. In the low load mode, the GPU 318 of each environmental camera 300 operates with a low upper limit value of the usage ratio. Accordingly, the load of the arithmetic processing can be reduced. In the high load mode, the GPU of each environmental camera 300 operates with a high upper limit value of the usage ratio. That is, the switching unit 1174 outputs a control signal for switching the upper limit value of the usage ratio of the GPU 318 in accordance with the mode. When the upper limit of the usage ratio is high, the processing load on the environmental camera 300 that is the edge device is high.

Therefore, in the low load mode, the GPU 318 executes the feature extraction process and the determination process at a low usage ratio. Therefore, in the high load mode, the GPU 318 executes the feature extraction process and the determination process at a high usage ratio. Accordingly, it is possible to improve the determination accuracy in the high load mode. Therefore, it is possible to effectively monitor the device user who moves alone, whereby appropriate control can be executed.

The switching unit 1174 switches at least one of the above items. This enables appropriate control depending on the environment. As a matter of course, the switching unit 1174 may switch two or more items. Furthermore, the items switched by the switching unit 1174 are not limited to the items illustrated in FIG. 5, and other items may be switched. Specifically, in the high load mode, more environmental cameras 300 may be used for monitoring. That is, some environmental cameras 300 and the like may be put to sleep in the low load mode. The switching unit 1174 can change the processing load by switching various items in accordance with the mode. Since the host management device 10 can flexibly change the processing load depending on the situation, the power consumption can be reduced.

When the determination process is executed in low load processing, the accuracy is lowered. Therefore, the process needs to be executed so as to facilitate switching to the high load mode. For example, in the low load mode, the probability of determining that the user is the device user and the probability of determining that the assistant is not present may be set higher than those in the high load mode.

Further, in the high load mode, the host management device 10 as a server may collect images from a plurality of the environmental cameras 300. The host management device 10 as a server may collect images from the cameras 25 mounted on one or more mobile robots 20. Then, the processing may be applied to images collected from a plurality of the cameras. Further, in the low load mode, the process may be executed solely by the edge device provided in the environmental camera 300 or the like. This enables appropriate control with more appropriate processing load.

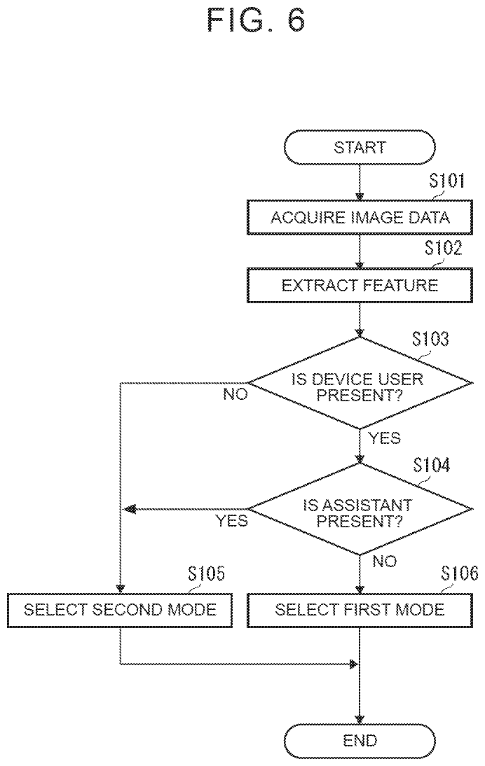

A control method according to the present embodiment will be described with reference to FIG. 6. FIG. 6 is a flowchart showing a control method according to the present embodiment. First, the image data acquisition unit 1170 acquires image data from the environmental camera 300 (S101). That is, when the environmental camera 300 captures images of the monitoring area, the captured images are transmitted to the host management device 10. The image data may be moving images or still images. Furthermore, the image data may be data obtained by applying various types of processing to the captured images.

Next, the feature extraction unit 1171 extracts the features of the person in the captured images (S102). Here, the feature extraction unit 1171 detects people included in the captured images and extracts features for each person. For example, the feature extraction unit 1171 extracts features for edge detection and shape recognition.

The first determination unit 1176 determines whether the device user is present based on the feature extraction result (S103). When the device user is not present (NO in S103), the switching unit 1174 selects the second mode (S105). The first determination unit 1176 performs the first determination based on the feature amount vector extracted from the image data. Accordingly, whether the person included in the captured image is the device user is determined. For example, when the assistive device is not detected near the person, the first determination unit 1176 determines that the person is not the device user. Therefore, monitoring as the low load processing in the second mode is performed. Note that, in the case where multiple persons are included in the captured image, when a determination is made that none of the persons is the device user, step S103 turns out to be NO.

When the device user is present (YES in S103), the second determination unit 1177 determines whether the assistant who assists the movement of the device user is present (S104). The second determination unit 1177 performs the second determination based on the feature amount vector extracted from the image data. Accordingly, whether the person included in the captured image is the assistant is determined. In the case where multiple persons are included in the captured image, when even a single person is the device user, step S103 turns out to be YES.

When the assistant is present (YES in S104), the switching unit 1174 selects the second mode (S105). For example, when a person is present near the device user, the second determination unit 1177 determines that the person is the assistant. Therefore, monitoring as the low load processing in the second mode is performed. The power consumption can be reduced by setting the second mode. Note that in the case where multiple device users are included in the captured image, when all the device users have assistants, step S104 turns out to be YES.

When the assistant is not present (NO in S104), the switching unit 1174 selects the first mode (S106). For example, when any person is not present near the device user, the second determination unit 1177 determines that the assistant is not present. Therefore, monitoring as the high load processing in the first mode is performed. With this configuration, the monitoring load is increased when the device user is alone. This allows the facility to be properly monitored. Further, the mobile robot 20 can quickly avoid the device user. In the case where multiple device users are included in the captured image, when at least one device user does not have the assistant, step S104 turns out to be NO.

Note that the features used in the first determination and the second determination may be the same or different. For example, at least part of the features used in the first determination and the second determination may be common. Further, in step S103, when the device user is not present (NO in S103), the switching unit 1174 selects the second mode (low load mode). However, another mode may further be selected. That is, since the monitoring load can be further reduced when the device user is not present, the switching unit 1174 may select a mode with a lower load than that of the second mode.

### Modification

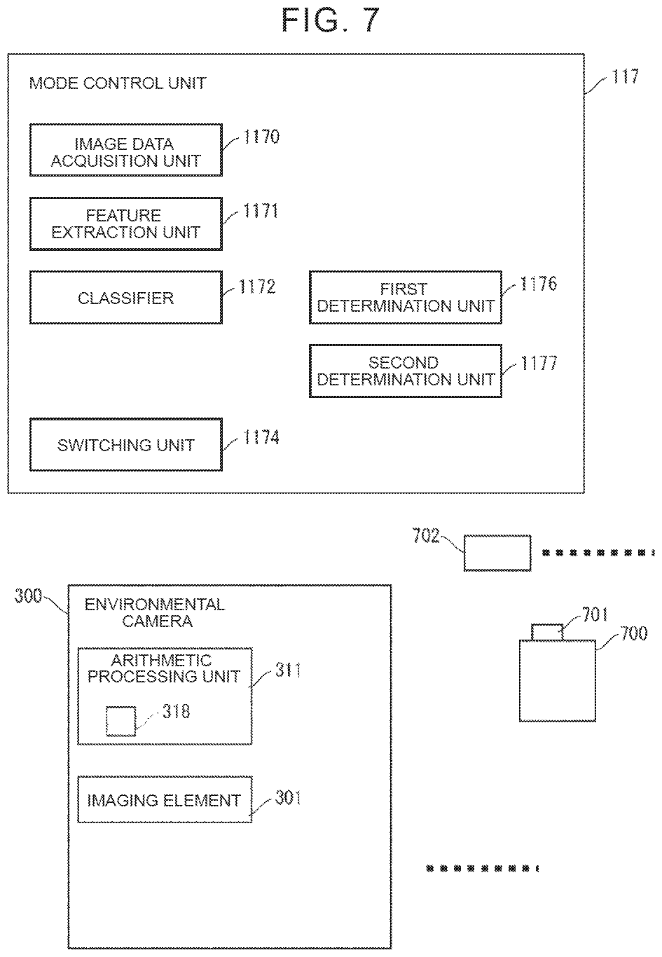

A modification will be described with reference to FIG. 7. In the modification, the mode control unit 117 includes a classifier 1172. Since the configuration other than the classifier 1172 is the same as that of the first embodiment, the description is omitted. The host management device 10 determines whether the user captured by the camera is a non-staff person. More specifically, the classifier 1172 classifies the users into a preset first group to which staff members belong and a preset second group to which non-staff persons belong. The host management device 10 determines whether the user captured by the camera belongs to the first group.

The classifier 1172 classifies the person into the first group or the second group that is set in advance based on the feature extraction result. For example, the classifier 1172 classifies the person based on the feature amount vector received from the feature extraction unit 1171 and the staff information 128 stored in the storage unit 12. The classifier 1172 classifies the staff member into the first group and the non-staff person into the second group. The classifier 1172 supplies the classification result to the switching unit 1174.

For classification by the classifier 1172, the feature extraction unit 1171 detects the clothing color of the detected person. More specifically, for example, the feature extraction unit 1171 calculates the ratio of the area occupied by the specific color from the clothing of the detected person. Alternatively, the feature extraction unit 1171 detects the clothing color in a specific portion from the clothes of the detected person. As described above, the feature extraction unit 1171 extracts the characteristic parts of the clothes of the staff member.

Further, the characteristic shape of the clothes or characteristic attachments of the staff member may be extracted as features. Furthermore, the feature of the facial image of the feature extraction unit 1171 may be extracted. That is, the feature extraction unit 1171 may extract features for face recognition. The feature extraction unit 1171 supplies the extracted feature information to the classifier 1172.

The switching unit 1174 switches the mode in accordance with the determination result as to whether the person belongs to the first group. When only persons belonging to the first group are present in the monitoring target area, that is, only the facility staff members are present in the monitoring target area, the switching unit 1174 switches the mode to a third mode. In the third mode, a process with a lower load than the loads of the first mode and the second mode is executed. In other words, it can also be defined that the first mode is the high load mode, the second mode is the medium load mode, and the third mode is the low load mode.

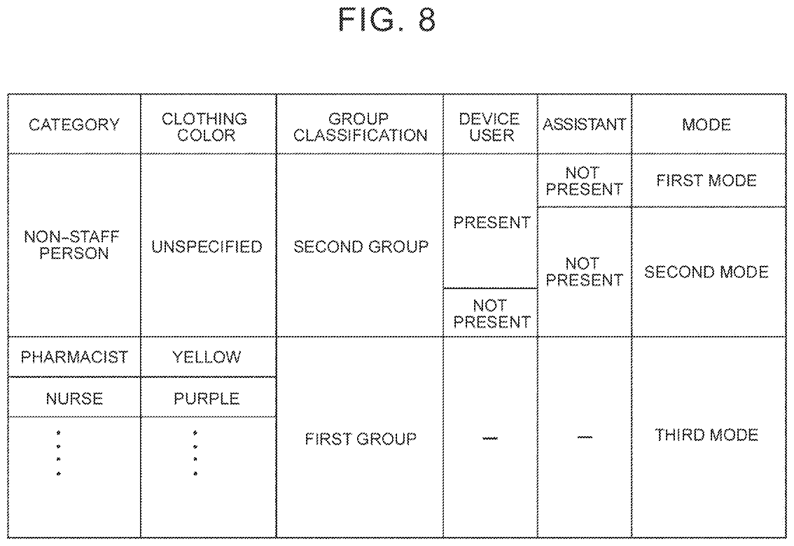

An example of the staff information 128 is shown in FIG. 8. FIG. 8 is a table showing an example of the staff information 128. The staff information 128 is information for classifying the staff member and the non-staff person into corresponding groups for each type. The left column shows “categories” of the staff members. Items in the staff category are shown from top to bottom: “non-staff person”, “pharmacist”, and “nurse”. As a matter of course, items other than the illustrated items may be included. The columns of “clothing color”, “group classification”, “speed”, and “mode” are shown in sequence on the right side of the staff category.

The clothing color (color tone) corresponding to each staff category item will be described below. The clothing color corresponding to “non-staff person” is “unspecified”. That is, when the feature extraction unit 1171 detects a person from the image data and the clothing color of the detected person is not included in the preset colors, the feature extraction unit 1171 classifies the detected person as the “non-staff person”. Further, according to the staff information 128, the group classification corresponding to the “non-staff person” is the second group.

The category is associated with the clothing color. For example, it is assumed that the color of staff uniform is determined for each category. In this case, the color of the uniform differs for each category. Therefore, the classifier 1172 can identify the category from the clothing color. As a matter of course, staff members in one category may wear uniforms of different colors. For example, a nurse may wear a white uniform (white coat) or a pink uniform. Alternatively, multiple categories of staff members may wear uniforms of a common color. For example, nurses and pharmacists may wear white uniforms. Furthermore, the shape of clothes, hats, etc., in addition to the clothing color may be used as features. The classifier 1172 then identifies the category that matches the feature of the person in the image. As a matter of course, when more than one person are included in the image, the classifier 1172 identifies the category of each person.

The classifier 1172 can easily and appropriately determine whether the person is a staff member by determining whether the person is a staff member based on the clothing color. For example, even when a new staff member is added, it is possible to determine whether the staff member is a staff member without using the staff member's information. Alternatively, the classifier 1172 may classify whether the person is the non-staff person or the staff member in accordance with the presence or absence of a name tag, ID card, entry card, or the like. For example, the classifier 1172 classifies a person with a name tag attached to a predetermined portion of the clothes as a staff member. Alternatively, the classifier 1172 classifies a person whose ID card or entry card is hung from the neck in a card holder or the like as a staff member.

Additionally, the classifier 1172 may perform classification based on features of the facial image. For example, the staff information 128 may store facial images of staff members or feature amounts thereof in advance. When the facial features of a person included in the image captured by the environmental camera 300 can be extracted, it is possible to determine whether the person is a staff member by comparing the feature amounts of the facial images. Further, when the staff category is registered in advance, the staff member can be specified from the feature amount of the facial image. As a matter of course, the classifier 1172 can combine multiple features to perform the classification.

As described above, the classifier 1172 determines whether the person in the image is a staff member. The classifier 1172 classifies the staff member into the first group. The classifier 1172 classifies the non-staff person into the second group. That is, the classifier 1172 classifies the person other than the staff member into the second group. In other words, the classifier 1172 classifies a person who cannot be identified as a staff member into the second group. Note that, although in some embodiments the staff members be registered in advance, a new staff member may be classified in accordance with the clothing color.

The classifier 1172 may be a machine learning model generated by machine learning. In this case, machine learning can be performed using images captured for each staff category as training data. That is, a machine learning model with high classification accuracy can be constructed by performing supervised learning using the image data to which staff categories are attached as correct labels as training data. In other words, it is possible to use captured images of staff members wearing predetermined uniforms as learning data.

The machine learning model may be a model that executes the feature extraction and the classification process. In this case, by inputting an image including a person to the machine learning model, the machine learning model outputs the classification result. Further, a machine learning model corresponding to the features to be classified may be used. For example, a machine learning model for classification based on the clothing colors and a machine learning model for classification based on the feature amounts of facial image may be used independently of each other. Then, when any one of the machine learning models recognizes the person as a staff member, the classifier 1172 determines that the person belongs to the first group. When the person cannot be identified as a staff member, the classifier 1172 determines that the person belongs to the second group.

The switching unit 1174 switches the mode based on the classification result, the first determination result, and the second determination result. Specifically, in an area where only staff members are present, the switching unit 1174 switches the mode to the third mode. That is, the switching unit 1174 switches the mode to the third mode in the area where only the staff members are present. Alternatively, in an area where no person is present, the switching unit 1174 sets the third mode. The switching unit 1174 switches the mode to the first mode in the area where the device user who is moving alone is present. The switching unit 1174 switches the mode to the second mode in the area where the device user is present but the device user who is moving alone is not present. Note that in a region where a person other than the staff member is present and the device user is not present, the switching unit 1174 switches the mode to the second mode. However, the switching unit 1174 may switch the mode to the third mode.

The control items shown in FIG. 5 are switched step by step as the switching unit 1174 outputs a control signal for switching. For example, the switching unit 1174 switches the control such that the first mode has the high load, the second mode has the medium load, and the third mode has the low load. For example, the frame rate may be a high frame rate, a medium frame rate, or a low frame rate. In this case, the medium frame rate is a frame rate between the high frame rate and the low frame rate.

Alternatively, the items for switching to the low load control may be changed in each mode. Specifically, in the second mode, only the machine learning model may be set to a low layer, and in the third mode, further, the camera pixels may be set to low pixels, the frame rate may be set to a low frame rate, and the number of used cores of the GPU may be set to be a low number. That is, in the third mode, the number of control items for reducing the load may be increased.

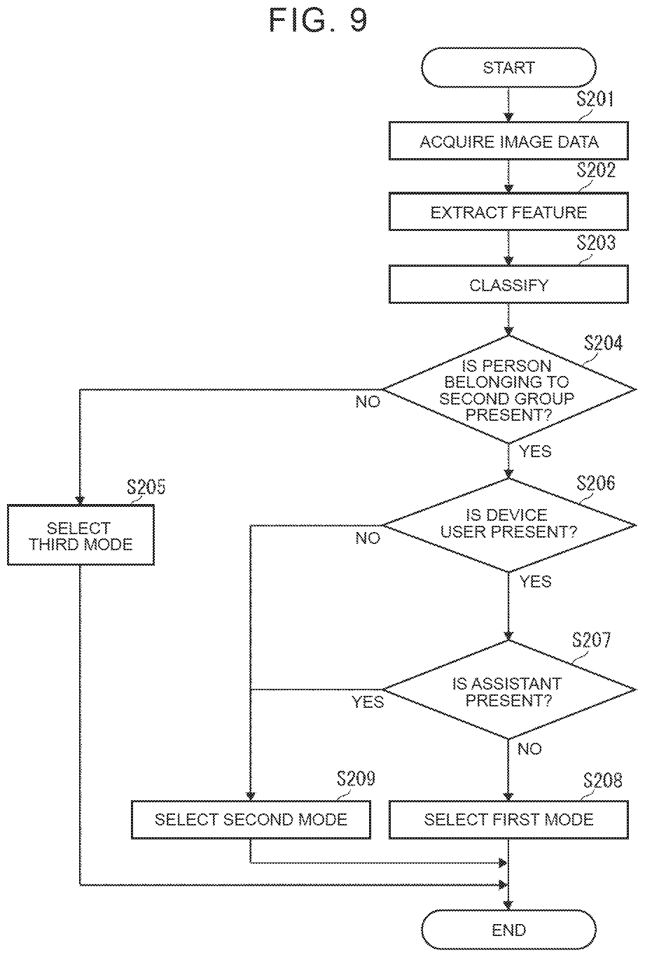

FIG. 9 is a flowchart showing a control method according to the present embodiment. First, the image data acquisition unit 1170 acquires image data from the environmental camera 300 (S201). That is, when the environmental camera 300 captures images of the monitoring area, the captured images are transmitted to the host management device 10. The image data may be moving images or still images. Furthermore, the image data may be data obtained by applying various types of processing to the captured images.

Next, the feature extraction unit 1171 extracts the features of the person in the captured images (S202). Here, the feature extraction unit 1171 detects people included in the captured images and extracts features for each person. For example, the feature extraction unit 1171 extracts the clothing color of the person as a feature. As a matter of course, the feature extraction unit 1171 may extract the feature amount for face recognition and the shape of the clothes, in addition to the clothing color. The feature extraction unit 1171 may extract the presence or absence of a nurse cap, the presence or absence of a name tag, the presence or absence of an ID card, etc. as features. The feature extraction unit 1171 may extract all features used for classification, the first determination, and the second determination.

The classifier 1172 classifies the person included in the captured image into the first group or the second group based on the person's features (S203). The classifier 1172 refers to the staff information and determines whether the person belongs to the first group based on the features of each person. Specifically, the classifier 1172 determines that the person belongs to the first group when the clothing color matches the preset color of the uniform. Accordingly, all persons included in the captured images are classified into the first group or the second group. As a matter of course, the classifier 1172 can perform classification using other features, in addition to the feature of clothing color.

Then, the classifier 1172 determines whether a person belonging to the second group is present within the monitoring area (S204). When the person belonging to the second group is not present (NO in S204), the switching unit 1174 selects the third mode (S205). The switching unit 1174 transmits a control signal for switching the mode to the third mode to edge devices such as the environmental camera 300 and the mobile robot 20. Accordingly, the host management device 10 performs monitoring with a low load. That is, since there is any non-staff person who behaves in an unpredictable manner, there is a low possibility that a person comes into contact with the mobile robot 20. Therefore, even when monitoring is performed with a low processing load, the mobile robot 20 can move appropriately. The power consumption can be suppressed by reducing the processing load. Moreover, even when any person is not present in the monitoring target area at all, the switching unit 1174 sets the mode of the monitoring target area to the third mode. Furthermore, when multiple persons are present in the monitoring target area but any person belonging to the second group is not present at all, the switching unit 1174 sets the mode of the monitoring target area to the third mode.

When a person belonging to the second group is present (YES in S204), the first determination unit 1176 determines whether the device user is present (S206). When the device user is not present (NO in S206), the switching unit 1174 selects the second mode (S209). For example, when the assistive device is not detected near the person, the first determination unit 1176 determines that the person is not the device user. Therefore, monitoring is performed in the second mode.

When the device user is present (YES in S206), the second determination unit 1177 determines whether the assistant who assists the movement of the device user is present (S207). When the assistant is not present (NO in S207), the switching unit 1174 selects the first mode (S208). For example, when any person is not present near the device user, the second determination unit 1177 determines that the assistant is not present. Therefore, monitoring is performed in the first mode. With this configuration, the monitoring load is increased when the device user is alone. This allows the facility to be properly monitored. Further, the mobile robot 20 can quickly avoid the device user.

When the assistant is present (YES in S207), the switching unit 1174 selects the second mode (S209). For example, when a person is present near the device user, the second determination unit 1177 determines that the person is the assistant. Therefore, monitoring is performed in the second mode. The power consumption can be reduced by setting the second mode than in the first mode. Furthermore, more intensive monitoring can be performed than in the third mode.

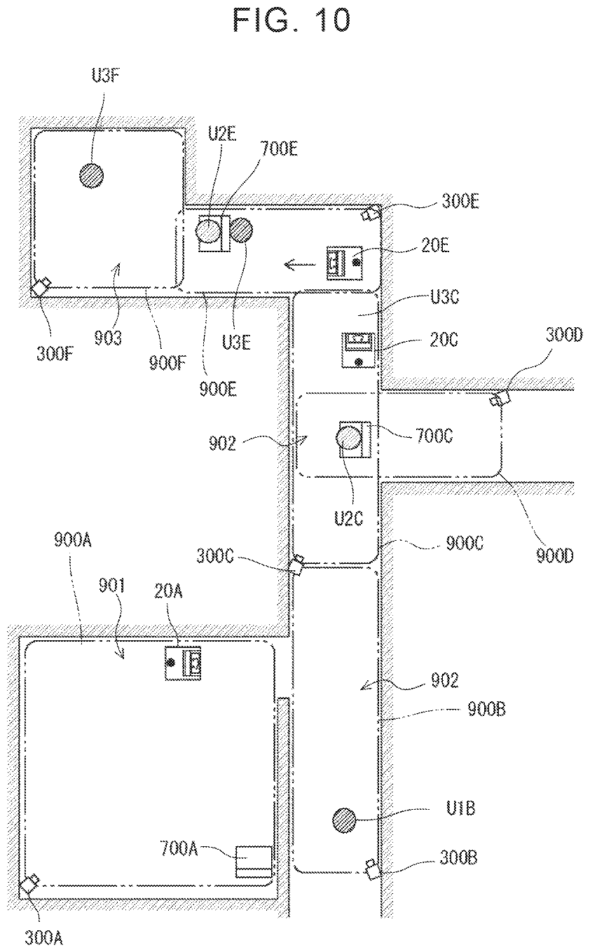

FIG. 10 is a diagram for illustrating a specific example of mode switching. FIG. 10 is a schematic diagram of the floor on which the mobile robot 20 moves, as viewed from above. A room 901, a room 903, and a passage 902 are provided in the facility. The passage 902 connects the room 901 and the room 903. In FIG. 10, six environmental cameras 300 are identified as environmental cameras 300A to 300F. The environmental cameras 300A to 300F are installed at different positions and in different directions. The environmental cameras 300A to 300F are imaging different areas. The positions, imaging directions, imaging ranges, and the like of the environmental cameras 300A to 300F may be registered in the floor map 121 in advance.

The areas assigned to the environmental cameras 300A to 300F are defined as monitoring areas 900A to 900F, respectively. For example, the environmental camera 300A captures an image of the monitoring area 900A, and the environmental camera 300B captures an image of the monitoring area 900B. Similarly, the environmental cameras 300C, 300D, 300E, and 300F capture images of the monitoring areas 900C, 900D, 900E, and 900F, respectively. As described above, the environmental cameras 300A to 300F are installed in the target facility. The facility is divided into multiple monitoring areas. Information on the monitoring areas may be registered in the floor map 121 in advance.

Here, for the sake of simplification of description, it is assumed that each of the environmental cameras 300A to 300F monitors one monitoring area, but one environmental camera 300 may monitor a plurality of monitoring areas. Alternatively, multiple environmental cameras 300 may monitor one monitoring area. In other words, the imaging ranges of two or more environmental cameras may overlap.

### First Example

In a first example, a monitoring area 900A monitored by the environmental camera 300A will be described. The monitoring area 900A corresponds to the room 901 within the facility. Since no user is present in the monitoring area 900A, the switching unit 1174 switches the mode of the monitoring area 900A to the third mode. Further, switching to the first mode is not performed because no person is present in the monitoring area 900A although there is an assistive device 700A.

The host management device 10 monitors the monitoring area 900A by low load processing. For example, the environmental camera 300A outputs a captured image with a low number of pixels. As a matter of course, the switching unit 1174 may output a control signal for setting other items to the low load mode. Further, the switching unit 1174 may output a control signal for setting the mobile robot 20A to the low load mode. There is no person in the monitoring area 900A. Therefore, the mobile robot 20A can move at high speed even when monitoring is performed with a low load in the third mode. The transport task can be executed efficiently.

### Second Example

In a second example, a monitoring area 900E monitored by the environmental camera 300E will be described. The monitoring area 900E corresponds to the passage 902 in the facility. Specifically, the monitoring area 900E is the passage 902 connected to the monitoring area 900F. A user U2E, a user U3E, and a mobile robot 20E are present in the monitoring area 900E.

The user U2E is the device user who uses an assistive device 700E. The assistive device 700E is a wheelchair or the like. The user U3E is an assistant who assists in the movement of the device user. The classifier 1172 classifies that the users U2E and U3E belong to the second group. The first determination unit 1176 determines that the user U2E is the device user. The second determination unit 1177 determines that the user U3E is the assistant. The switching unit 1174 switches the mode of the monitoring area 900E to the second mode.

The host management device 10 monitors the monitoring area 900E by medium load processing. For example, the environmental camera 300E outputs a captured image at a medium frame rate. As a matter of course, the switching unit 1174 may output a control signal for setting other items to the medium load mode. Further, the switching unit 1174 may output a control signal for setting the mobile robot 20E to the medium load mode.

### Third Example

In a third example, a monitoring area 900C and a monitoring area 900D monitored by the environmental cameras 300C and 300D will be described. The monitoring area 900C and the monitoring area 900D correspond to the passage 902 in the facility. The user U2C is present in the monitoring area 900C and the monitoring area 900D. The user U2C is the device user who moves alone. That is, the user U2C is moving on an assistive device 700C such as a wheelchair. The assistant who assists the movement is not present around the user U2C.

The classifier 1172 classifies that the user U2C belongs to the second group. The first determination unit 1176 determines that the user U2C is the device user. The second determination unit 1177 determines that the assistant is not present. The switching unit 1174 switches the modes of the monitoring area 900C and the monitoring area 900D to the first mode.

The host management device 10 monitors the monitoring area 900C and the monitoring area 900D by high load processing. For example, the environmental camera 300C and the environmental camera 300D output captured images at a high frame rate. As a matter of course, the switching unit 1174 may output a control signal for setting other items to the high load mode. Further, the switching unit 1174 may output a control signal for setting the mobile robot 20C to the high load mode.

### Fourth Example

In a fourth example, a monitoring area 900F monitored by the environmental camera 300F will be described. The monitoring area 900F corresponds to the room 903 within the facility. The user U3F is present in the monitoring area 900F. The user U3F is a non-staff person who does not use the assistive device.

The classifier 1172 classifies that the user U3F belongs to the second group. The first determination unit 1176 determines that the user U3F is not the device user. The switching unit 1174 switches the mode of the monitoring area 900F to the second mode.

The switching unit 1174 switches the mode of the monitoring area 900F to the second mode. The host management device 10 monitors the monitoring area 900F by medium load processing. For example, the environmental camera 300F outputs a captured image at a medium frame rate. As a matter of course, the switching unit 1174 may output a control signal for setting other items to the medium load mode.

### Fifth Example

In a fifth example, a monitoring area 900B monitored by the environmental camera 300B will be described. The monitoring area 900B corresponds to the passage 902 in the facility. The user U1B is present in the monitoring area 900B. The user U1B is a staff member. The non-staff person is not present in the monitoring area 900B.

The classifier 1172 classifies that the user U1B belongs to the first group. The switching unit 1174 switches the mode of the monitoring area 900B to the third mode. The host management device 10 monitors the monitoring area 900B by low load processing. For example, the environmental camera 300B outputs a captured image at a low frame rate. As a matter of course, the switching unit 1174 may output a control signal for setting other items to the low load mode.

The control method according to the present embodiment may be performed by the host management device 10 or by the edge device. Further, the environmental camera 300, the mobile robot 20, and the host management device 10 may operate together to execute the control method. That is, the control system according to the present embodiment may be installed in the environmental camera 300 and the mobile robot 20. Alternatively, at least part of the control system or the entire control system may be installed in a device other than the mobile robot 20, such as the host management device 10.

The host management device 10 is not limited to being physically a single device, but may be distributed among a plurality of devices. That is, the host management device 10 may include multiple memories and multiple processors.

Further, part of or all of the processes in the host management device 10, the environmental cameras 300, the mobile robot 20, or the like described above can be realized as a computer program. The program as described above is stored using various types of non-transitory computer-readable media, and can be supplied to a computer. The non-transitory computer-readable media include various types of tangible recording media. Examples of the non-transitory computer-readable media include magnetic recording media (e.g. flexible disks, magnetic tapes, hard disk drives), magneto-optical recording media (e.g. magneto-optical disks), compact disc read-only memory (CD-ROM), compact disc recordable (CD-R), compact disc rewritable (CD-R/W), and semiconductor memory (e.g. mask ROM, programmable ROM (PROM), erasable PROM (EPROM), flash ROM, random access memory (RAM)). Further, the program may also be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The present disclosure is not limited to the above embodiment, and can be appropriately modified without departing from the spirit. For example, in the above-described embodiment, a system in which a transport robot autonomously moves within a hospital has been described. However, the above-described system can transport predetermined articles as luggage in hotels, restaurants, office buildings, event venues, or complex facilities.

What is claimed is:

1. A control system comprising:
a feature extraction unit that extracts a feature of a person in a captured image captured by a camera;
a first determination unit that determines, based on a feature extraction result, whether the person included in the captured image is a device user who uses an assistive device for assisting movement;
a second determination unit that determines, based on the feature extraction result, whether an assistant who assists movement of the device user is present; and
a control unit that switches between a first mode and a second mode that executes a process with a lower load than a load in the first mode depending on whether the assistant is present.

2. The control system according to claim 1, further comprising a classifier that classifies, using a machine learning model, the person included in the captured image into a first group and a second group set in advance.

3. The control system according to claim 2, wherein a network layer of the machine learning model is changed depending on a mode.

4. The control system according to claim 1, wherein a number of pixels of an image captured by the camera, a frame rate of the camera, a number of used cores of a graphic processing unit, and an upper limit of a usage ratio of the graphic processing unit are changed depending on a mode.

5. The control system according to claim 1, wherein a server collects images from a plurality of the cameras and executes a process in the first mode, and edge devices provided in the camera alone execute a process in the second mode.

6. The control system according to claim 1, further comprising a mobile robot that moves autonomously in a facility, wherein control of the mobile robot is switched depending on whether the assistant is present.

7. A control method comprising:
a step of extracting a feature of a person in a captured image captured by a camera;
a step of determining, based on a feature extraction result, whether the person included in the captured image is a device user who uses an assistive device for assisting movement;
a step of determining, based on the feature extraction result, whether an assistant who assists movement of the device user is present; and
a step of switching between a first mode and a second mode that executes a process with a lower load than a load in the first mode depending on whether the assistant is present.

8. The control method according to claim 7, further comprising a step of classifying, using a machine learning model, the person included in the captured image into a first group and a second group set in advance.

9. The control method according to claim 8, wherein a network layer of the machine learning model is changed depending on a mode.

10. The control method according to claim 7, wherein a number of pixels of an image captured by the camera, a frame rate of the camera, a number of used cores of a graphic processing unit, and an upper limit of a usage ratio of the graphic processing unit are changed depending on a mode.

11. The control method according to claim 7, wherein a server collects images from a plurality of the cameras and executes a process in the first mode, and edge devices provided in the cameras alone execute a process in the second mode.

12. The control method according to claim 7, wherein control of a mobile robot is switched depending on whether the assistant is present.

13. A non-transitory storage medium storing a program causing a computer to execute a control method comprising:
a step of extracting a feature of a person in a captured image captured by a camera;
a step of determining, based on a feature extraction result, whether the person included in the captured image is a device user who uses an assistive device for assisting movement;
a step of determining, based on the feature extraction result, whether an assistant who assists movement of the device user is present; and
a step of switching between a first mode and a second mode that executes a process with a lower load than a load in the first mode depending on whether the assistant is present.

14. The storage medium according to claim 13, wherein the control method further includes a step of classifying, using a machine learning model, the person included in the captured image into a first group and a second group set in advance.

15. The storage medium according to claim 14, wherein a network layer of the machine learning model is changed depending on a mode.

16. The storage medium according to claim 13, wherein a number of pixels of an image captured by the camera, a frame rate of the camera, a number of used cores of a graphic processing unit, and an upper limit of a usage ratio of the graphic processing unit are changed depending on a mode.

17. The storage medium according to claim 13, wherein a server collects images from a plurality of the cameras and executes a process in the first mode, and edge devices provided in the cameras alone execute a process in the second mode.

18. The storage medium according to claim 13, wherein control of a mobile robot is switched depending on whether the assistant is present.
